(19) United States
(12) Patent Application Publication
(10) Pub. No.: US 2013/0201331 A1
(43) Pub. Date: Aug. 8, 2013

(54) INTERACTING WITH A PET FROM A REMOTE LOCATION

(71) Applicant: CAT2SEE, Kfar-Saba (IL)

(72) Inventors: Gilad GELFAND, Herzliya (IL); Amir GUTERMAN, Kfar Saba (IL); Gadi SAUDIAN, Herzliya Pituach (IL)

(73) Assignee: CAT2SEE, Kfar-Saba (IL)

(21) Appl. No.: 13/753,553

(22) Filed: Jan. 30, 2013

Related U.S. Application Data
(60) Provisional application No. 61/596,241, filed on Feb. 8, 2012.

(51) Int. Cl. H04N 7/18

(52) U.S. Cl. CPC H04N 7/18
USPC 348/143

(57) ABSTRACT

A system implementable on a computing device for remote interaction with a household pet. The system includes a remote sight display displaying a video feed received via a communication network from a stationary live video camera viewing a location housing the household pet and at least one remotely controllable accessory. The system also includes a non-line of sight remote controller to receive commands from a user viewing the remote sight display to control, via the communication network, the movement of the at least one remotely controllable accessory with which the pet interacts in response to the movement.

### CROSS-REFERENCE TO RELATED APPLICATIONS

This application claims priority from U.S. Provisional Patent Application No. 61/596,241, filed Feb. 8, 2012 which is hereby incorporated in its entirety by reference.

### FIELD OF THE INVENTION

The present invention relates to remote interactions with pets generally.

### BACKGROUND OF THE INVENTION

A pet is a household animal often kept for companionship and the more popular pets are usually known for their loyalty or playful characteristics. People will often spend hours interacting with their pets when they are home, from taking care of them physically such as walking or feeding them or just by passing the time playing with them. One of the most popular pets in the Western world today is the cat. Cats make good pets since they are relatively clean animals that groom themselves, because they have an innate curiosity and because they love to play.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of system for remote interaction with a pet constructed and operative in accordance with the present invention;

FIG. 2 is a schematic illustration of an exemplary implementation of the system of FIG. 1, constructed and operative in accordance with the present invention;

FIGS. 3A and 3B are block diagram illustrations of the elements of a remote mobile device and a home computer, forming part of the system of FIG. 1, constructed and operative in accordance with the present invention;

FIGS. 4A, 4B and 4C are schematic illustrations of a multi-purpose controllable base system for accessories, constructed and operative in accordance with the present invention;

FIGS. 5A and 5B are schematic illustrations of a remote dry food feeding system. constructed and operative in accordance with the present invention;

FIGS. 6A and 6B are schematic illustration of a remote wet food feeding system, constructed and operative in accordance with the present invention;

FIGS. 7A and 7B are a schematic illustrations of the use of repeater units constructed and operative in accordance with the present invention;

FIG. 8 is an alternative embodiment of the use of the repeater units of FIGS. 7A and 7B constructed and operative in accordance with the present invention; and

FIG. 9 is a schematic illustration of a cat lover server, constructed and operative in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY OF THE PRESENT INVENTION

There is provided, in accordance with a preferred embodiment of the present invention a system implementable on a computing device for remote interaction with a household pet. The system includes a remote sight display displaying a video feed received via a communication network from a stationary live video camera viewing a location housing the household pet and at least one remotely controllable accessory. The system also includes a non-line of sight remote controller to receive commands from a user viewing the remote sight display to control, via the communication network, the movement of the at least one remotely controllable accessory with which the pet interacts in response to the movement.

Moreover, in accordance with a preferred embodiment of the present invention, the non-line of sight controller includes a modem to send the commands to a home module.

Further, in accordance with a preferred embodiment of the present invention, the home module is installable on a personal computer or mobile communication device.

Still further, in accordance with a preferred embodiment of the present invention, the home module includes a coordinator to receive the commands and to instruct the at least one remotely controllable accessory to move accordingly.

Additionally, in accordance with a preferred embodiment of the present invention, the home module comprises a video communication module to receive the video feed from the camera and to send the video feed to the remote sight display.

Moreover, in accordance with a preferred embodiment of the present invention, the device is at least one of a mobile communication device and a personal computer.

Further, in accordance with a preferred embodiment of the present invention, the live video camera is at least one of a webcam, an IP camera, a USB camera and a Bluetooth camera.

Still further, in accordance with a preferred embodiment of the present invention, the communication network is at least one of a cellular communication network and the internet.

Additionally, in accordance with a preferred embodiment of the present invention, the accessory is the live video camera.

Moreover, in accordance with a preferred embodiment of the present invention, the accessory includes a multi-purpose base attachable to a piece of furniture.

Further, in accordance with a preferred embodiment of the present invention, the accessory includes a pet friendly toy attached to the base via a rotatable rod.

Still further, in accordance with a preferred embodiment of the present invention, the accessory is a dry food dispenser.

Additionally, in accordance with a preferred embodiment of the present invention, the accessory is a wet food dispenser.

Moreover, in accordance with a preferred embodiment of the present invention, the accessory is a water dispenser.

Further, in accordance with a preferred embodiment of the present invention, the base comprises a USB repeater and at least two USB connectors.

There is provided, in accordance with a preferred embodiment of the present invention a method for remote interaction with a household pet implementable on a computing device. The method includes displaying the state of at least one remotely controllable accessory via a communication network and controlling movement of the at least one controllable accessory according to an interaction of the pet with the accessory.

Moreover, in accordance with a preferred embodiment of the present invention, the controlling includes sending commands to a home module via a modem.

Further, in accordance with a preferred embodiment of the present invention, the home module is installable on a personal computer or a mobile communication device.

Still further, in accordance with a preferred embodiment of the present invention, the home module comprises a coordinator to receive the commands and to instruct the at least one remotely controllable accessory to move accordingly.

Additionally, in accordance with a preferred embodiment of the present invention, the home module comprises a video communication module to receive a video feed from a camera and to send the video feed to a remote sight display.

Moreover, in accordance with a preferred embodiment of the present invention, the camera is at least one of a webcam, an IP camera, a USB camera and a Bluetooth camera.

Additionally, in accordance with a preferred embodiment of the present invention, the communication network is at least one of a cellular communication network and the internet.

Further, in accordance with a preferred embodiment of the present invention, the accessory is the live video camera.

Still further, in accordance with a preferred embodiment of the present invention, the accessory includes a multi-purpose base attachable to a piece of furniture.

Additionally, in accordance with a preferred embodiment of the present invention, the accessory includes a pet friendly toy attached to the base via a rotatable rod.

Still further, in accordance with a preferred embodiment of the present invention, the accessory is a dry food dispenser.

Moreover, in accordance with a preferred embodiment of the present invention, the accessory is a wet food dispenser.

Further, in accordance with a preferred embodiment of the present invention, the accessory is a water dispenser.

Still further, in accordance with a preferred embodiment of the present invention, the base comprises a USB repeater and at least two USB connectors.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that pet lovers, away from their pet for many hours of the day, may appreciate ways to interact with their pet remotely. In particular, pet lovers may not wish to leave their pet unattended and unstimulated for long periods of time while they are away from home.

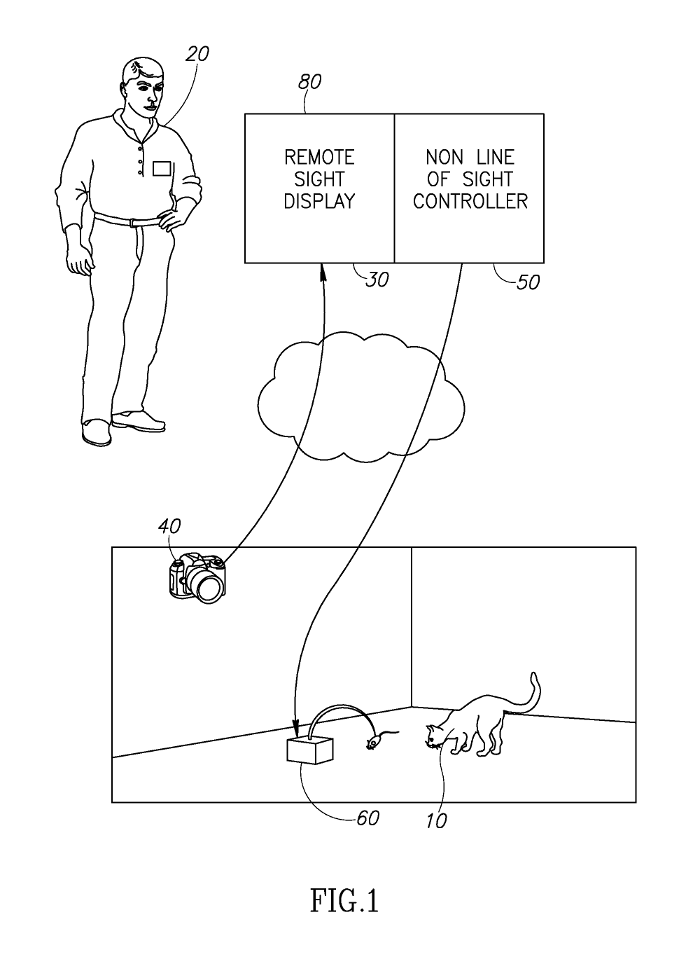

Reference is now made to FIG. 1 which illustrates a novel system for remote interaction with a pet. The present discussion will use a cat, labeled 10, as an example pet. It will be appreciated that the discussion may be applicable to other pets as well.

In accordance with a preferred embodiment of the present invention, cat 10, situated in a pertinent area of his home, may be monitored from afar by his owner 20 via a remote sight display 30 on a mobile communication device 80 belonging to owner 20. Remote sight display 30 may receive signals from a camera 40 which may be affixed at a suitable monitoring position within the home. Owner 20 may view and remotely control accessory 60 also situated in the same pertinent part of the home using a non-line of sight controller 50, also forming part of device 80. Accessory 60 may be a favorite toy of cat 10, such as a mouse attached to a movable fishing rod 200 (described in more detail hereinbelow) mounted in easy reach of the cat. When accessory 60 moves (as directed by owner 20 via non-line of sight controller 50), cat 10 may chase after it and try to catch the mouse.

It will be appreciated that remote sight display 30 and non-line of sight controller 50, may also be implemented on a non-mobile communication device such as a regular personal computer.

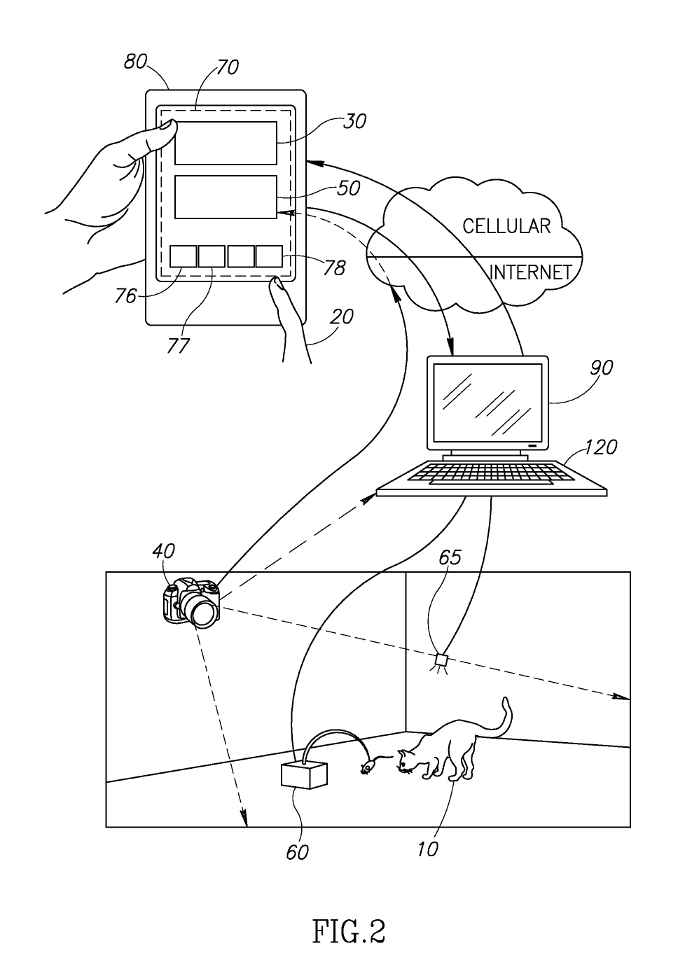

Reference is now made to FIG. 2 which illustrates a possible implementation of the above mentioned system. Remote sight display 30 and non-line of sight controller 50 may be controlled by an application 70 (herein known as “animal game”), downloaded to mobile communication device 80. Mobile communication device 80 may be in remote communication with a home computer 90 (situated near camera 40 and accessory 60) via an IP address of home computer 90. For example, mobile communication device 80 may communicate via a cellular network 100 which, in turn, may communicate to the Internet 110 to which home computer 90 may be connected.

Camera 40 may be any form of digital camera, such as a basic webcam attached to computer 90 or a “pan, tilt, zoom” such as an IP, USB or Bluetooth camera all with connection capabilities to computer 90. Home computer 90 may comprise a game controller application 120 that receives commands from mobile communication device 80, such as from controller 50, in order to control accessory 60 and/or camera 40 and to receive video signals from camera 40. Thus, owner 20 may monitor the position of cat 10 in relation to accessory 60, via remote sight display 30 of the output of camera 40, and may maneuver accessory 60 accordingly, via non-line of sight controller 50, in order to interact with cat 10. It will be appreciated that when animal game 70 is activated on its mobile communication device 80, the screen 130 of device 80 may change accordingly (as illustrated in FIG. 2). Animal game 70 may utilize a section of a screen 130 of device 80 to implement remote sight display 30, a second section of screen 130 to implement non-line of sight controller 50 and a third section of screen 130 to implement a set of mode control buttons 76, 77, 78 to select a required mode. For example, when camera mode is selected, owner 20 may view the output from camera 40 and may utilize non line of sight controller 50 to maneuver the angle of the camera to a desired position When an accessory mode is selected, owner 20 may still see the video streaming from camera 40 (which may be focused on accessory 60), but non line of sight controller 50 may control the movements of accessory 60 instead. It will be appreciated that there may be more than one accessory mode available, one for each of the available accessories.

It will be also appreciated that owner 20 may also be able to “talk” to cat 10 via speaker 65 which may be part of home computer 90 situated near cat 10 or may be connected to home computer 90 via some form of communication network (Internet, Bluetooth etc.) or by a USB cable. When animal game 70 is activated, owner 20 may be able to speak to cat 10 using the inbuilt microphone of mobile communication device 80. Using the same wireless connections as mentioned hereinabove, cat 10 may be able hear the voice of owner 20 via speaker 65. Since owner 20 may be able to view cat 10 simultaneously via remote site display 30, owner 20 may view the reaction of cat 10 to his voice and may adjust his voice and speak accordingly.

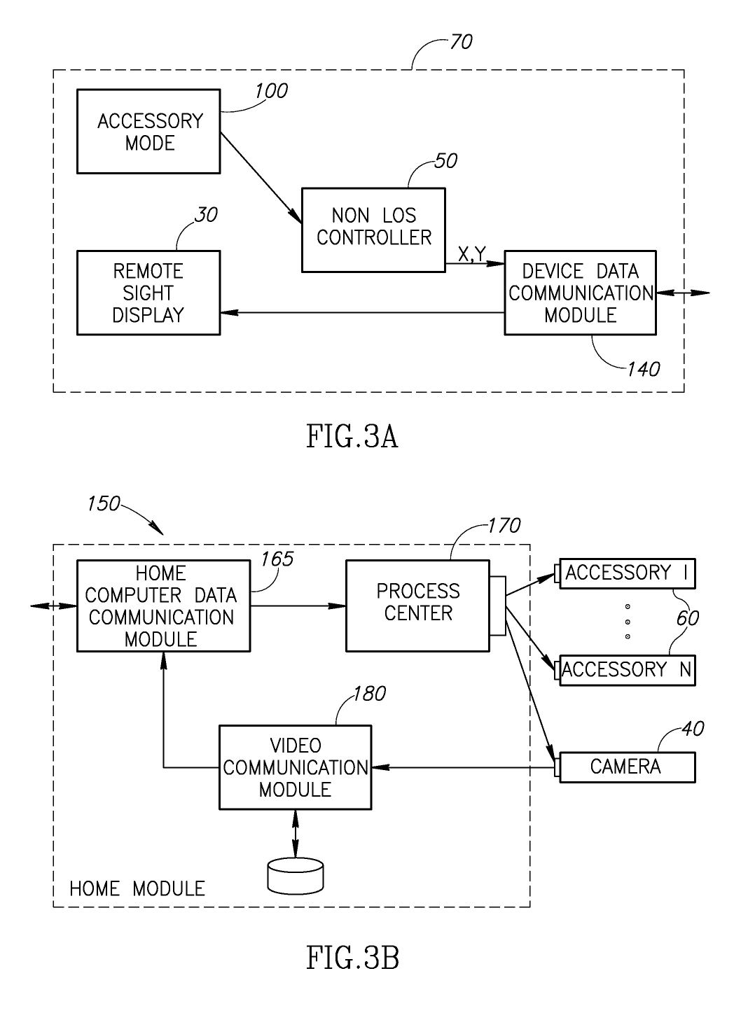

Reference is now made to FIGS. 3A and 3B which detail the elements of the above mentioned system. FIG. 3A details the elements of animal game 70. Animal game 70 may comprise an accessory mode module 100, non-line of sight controller 50, remote site display 30 and device data communication module 140.

Accessory mode module 100 may be utilized to select the required accessory mode, and non-line of sight controller 50 may be updated accordingly as to which accessory 60 has been chosen. Data regarding the accessory 60 to be controlled and the desired coordinates to position it, as received from controller 50, may then be sent to the IP address of home computer 90 via device data communication module 140. This may typically be a cellular modem. Device data communication module 140 may also receive streaming video and may display it on remote sight display 30. It will be appreciated that mobile communication device 80 may have a data connection to at least one communication network.

Reference is now made to FIG. 3B which illustrates the home module 150 of the above mentioned system. Home module 150 may comprise home computer data communication module 165, process center 170, and video communication module 180, all typically installed on home computer 90. Home module 150 may communicate with accessories 60 and camera 40.

Home computer data communication module 165, which may typically be an internet modem, may receive incoming data via communication networks 100, 110 (cellular, Internet etc.) Process center 170 may then process the incoming data to determine which accessory 60/camera 40 is to be moved and how according to the relevant coordinates received. Process center 170 may then instruct the pertinent accessory 60 to move appropriately via an existing data connection such as Bluetooth or via the IP address of the relevant accessory 60 if there is an appropriate modem.

It will further be appreciated that video output from camera 40 may be streamed by video communication module 180 and may be transmitted via home computer device module 150 to the IP address of mobile communication device 80. The streaming video may then be received by device data communication module 140, and may be displayed on remote sight display 30. In an alternative embodiment, camera 40 may be an IP camera and therefore, video streaming from camera 40 may be transmitted transparently to the IP address of mobile communication device 80. In either embodiment, owner 20 may control accessory 60 with the aid of the visual provided by remote sight display 30.

In a further embodiment, video communication module 180 may be connected to a recording device 190, in order to save and store the live video feed for later viewing. Recording device 190 may also be activated via animal game 70.

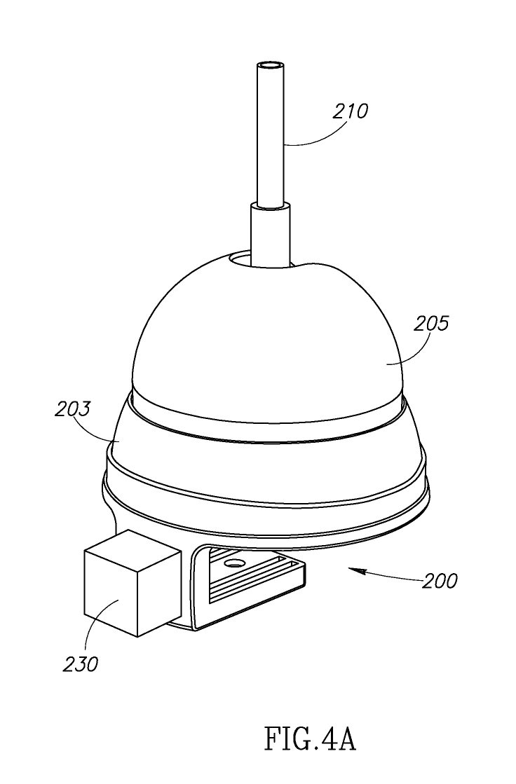

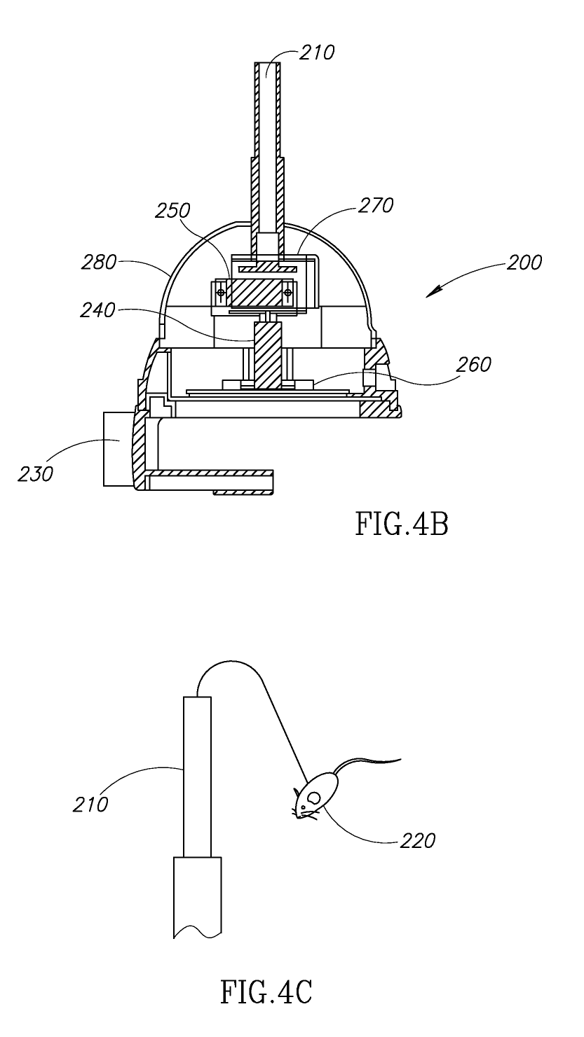

Reference is now made to FIGS. 4A and 4B which together illustrate a multi-purpose controllable base system 200 attachable to a piece of furniture in reach of cat 10, where FIG. 4A is a front view of system 200 and FIG. 4B is a side view. It will be appreciated that multi-purpose controllable base system 200 may be used to attach different accessories 60 in reach of cat 10 in order to control them and thus interact with cat 10.

Base system 200 may comprise of a base 203, a dome 205 and a modem 230. Dome 205 may also comprise a rod 210, motors 240 and 250 and platforms 260 and 270. Rod 210 may be further connected to either camera 40 or to any suitable accessory 60 such as a fishing rod and mouse toy 220 as illustrated in FIG. 4C to which reference is now made

Motor 240 may receive instructions via modem 230 and may rotate around its axis accordingly. When motor 240 begins to rotate, platform 260 to which it may be attached may also begin to rotate. Since platform 260 may also connected to the base of dome 205, the entire dome 205 together with rod 210 may also rotate accordingly. Therefore, any attachment at the end of rod 210 may also rotate accordingly. Alternatively, motor 250 may also receive instructions via modem 230 in conjunction with motor 240 or separately. Motor 250 may be positioned perpendicularly to motor 240 and be attached to platform 270. Platform 270 may also be attached to rod 10. It will be appreciated, that when motor 250 is activated, it rotates perpendicularly to motor 240 and thus rod 10 may be moved up and down within opening 280. Thusly, rod 10 together with any attachment it may have, may be swiveled, raised and lowered accordingly.

It will be appreciated that motors 240 and 250 may be rotated accordingly corresponding to instructions sent by process center 170, via modem 230 through the available communication network. It will be further appreciated that the range of movement of motors 240 and 250 may correspond to the x and y coordinates of the selected position from non-line of sight controller 50. Motor 240 may rotate according to the selected x coordinate and motor 250 according to the y coordinate. It will be appreciated that the attachment of camera 40 to rod 210 may provide a pan and tilt capability to camera 40.

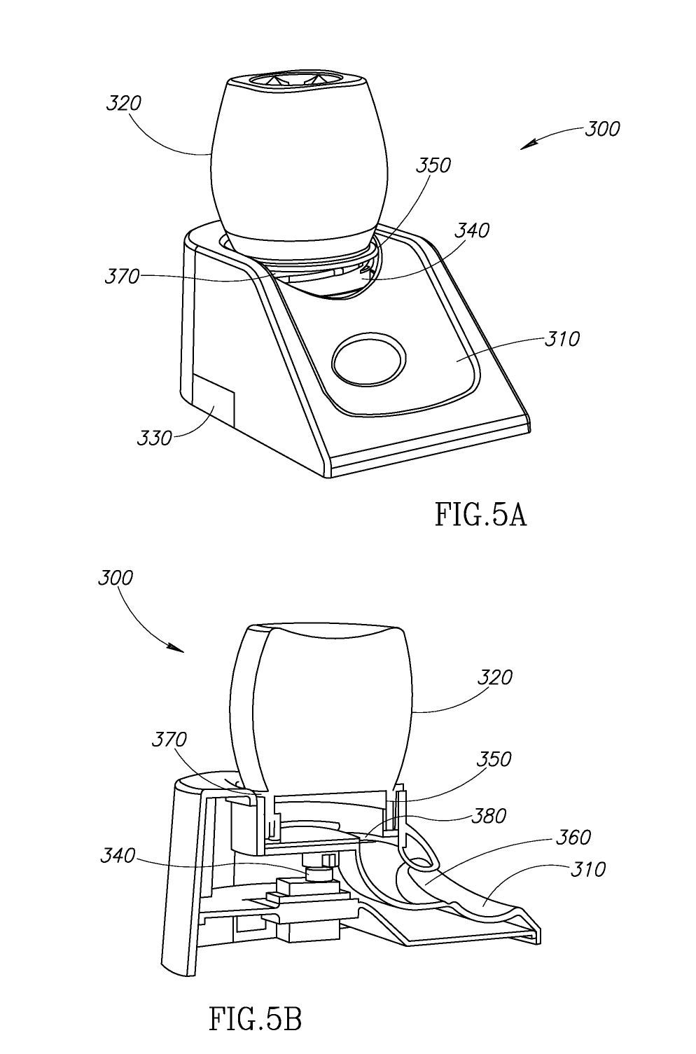

Reference is now made to FIGS. 5A and 5B which illustrate a remote dry food feeding system 300. FIG. 5A is a front view of remote dry food feeding system 300 and FIG. 5B is a side view. Dry food feeding system 300 may comprise a feeding trough 310, a food container 320, a modem 330 and a motor 340 to which a rotatable semi-disk 350 is attached.

Owner 20 from afar, while viewing cat 10 via remote sight display 30, may also see that feeding trough 310 belonging to cat 10 may need to be refilled. Owner 20, using animal game 70, may remotely instruct remote dry food feeding system 300 to release food from food container 320 and to dispense the food into feeding trough 310. Motor 340 may receive instructions via modem 330 and may rotate its axis accordingly which may cause rotatable semi-disk 350 to move. The range of rotation may be according to the coordinates selected from controller 70.

It will be appreciated that food may be dispensed into feeding trough 310 via slide 360 from the base 370 of food container 320 as illustrated in FIG. 5B. It will further be appreciated that the base 370 of food container 320 may be situated over rotatable semi-disk 350. When communication motor 340 is at rest, rotating semi-disk 350 may block the flow of food from food container 320 to slide 360 by being physically situated at the apex 380 of slide 360. When motor 340 begins to rotate accordingly, apex 380 may be unblocked and food may flow freely down slide 360 into feeding trough 310. It will be appreciated that the amount of food released into feeding trough 310 may be controlled via the range of movement available for rotatable semi-disk 350, which in turn may be controlled via animal game 70. A small rotation may partially open apex 380 and may disperse a smaller amount of food. Thusly owner 20 has full control from afar, of the amount of food being dispensed to cat 10.

In an alternative embodiment, dry food feeding system 300 may be filled with water instead of food which may be dispensed to feeding trough 310 in the same manner.

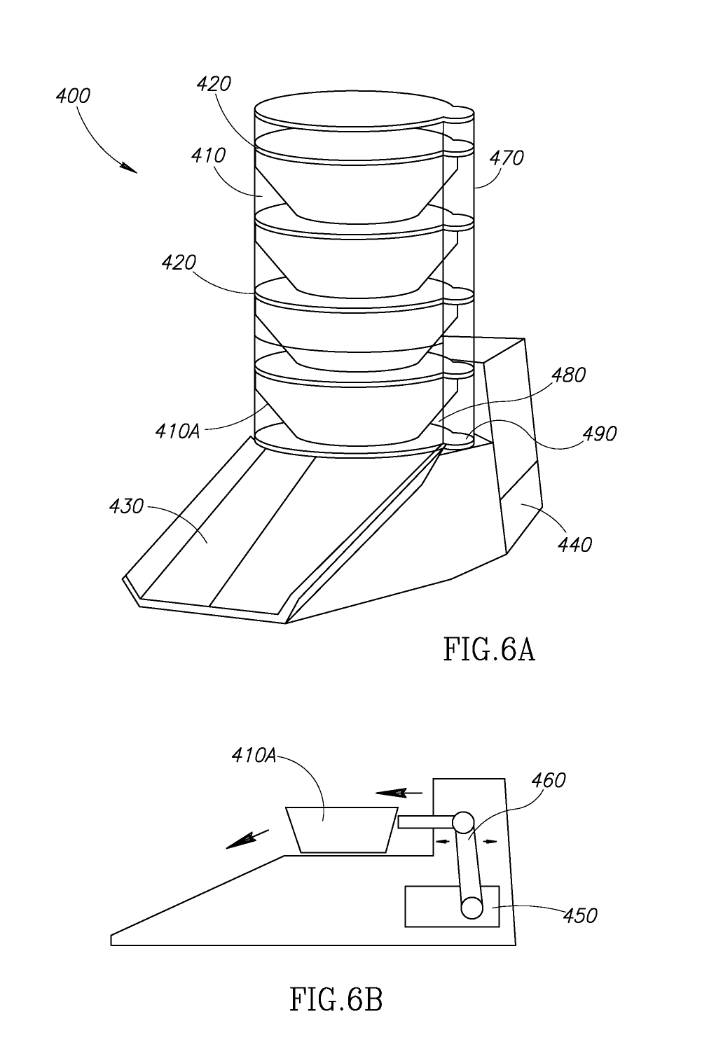

Reference is now made to FIG. 6A which illustrates a front view of a remote wet food dispenser 400 also controllable from afar via animal game 70. Wet food dispenser 400 may comprise a holder 470, cups 410, lids 420, a dispensing ramp 430, a modem 440, a motor 450 and a moveable arm 460 (as illustrated in FIG. 6B). Wet food such as tinned meat may be stored in cups 410 sealable with lids 420. These sealed cups 410 may be stored in a stack formation within holder 470. It will be appreciated that holder 470 may be designed accordingly to ensure that stacked cups 410 are held rigidly in position.

Reference is now made to FIG. 6B which illustrates moveable arm 460, attached to motor 450. Moveable arm 460 may be located behind holder 470, with moveable arm 460 leveled with the lowest cup, labeled 410A, in the stack. Motor 450 may receive instructions via modem 440 and may rotate around its axis accordingly. It will be appreciated that the range of rotation may be according to the coordinates selected from controller 70.

Motor 450 may move moveable arm 460 with a forward motion strong enough to push the lowest cup 410A in the stack. It will be appreciated that this pushing force may dislodge lower cup 410A from its rigidly held position and may push it through aperture 480 and down dispensing ramp 430. Lid 420 may have an extension 490 which may be held in place by holder 470 keeping it from moving when cup 410 moves through aperture 180. Thus, lid 420 may therefore remain at the base of holder 470 while cup 410A slides down dispensing ramp 430 to the awaiting cat 10. Once lower cup 410A has been dislodged from its position, the next cup 410 in the stack may fall and take its place, as will all the other cups 410 in the stack. It will be appreciated that cups 410 and lids 420 may be reusable and that they may be refilled and restacked in holder 470 for later use.

As discussed hereinabove, home module 150 installed on home computer 90 may instruct the pertinent accessory 60 and/or camera 40 via an existing data connection such as Bluetooth or through a USB cable. It will be appreciated that the range of such a Bluetooth connection may be short, restricting the maximum distance between home computer 90 and the optimal physical location of accessory 60 and/or camera 40. It will be further appreciated that, while the maximum distance of a USB connection may be longer than that of a Bluetooth connection, the distance the accessory may be placed is still limited. It will be also appreciated that the connection of camera 40 and multiple accessories 60 to the home computer 90 via USB cables may occupy potentially available USB ports of home computer 90 and may also cause an unwanted maze of cables which may not be so desirable in the presence of cat 10.

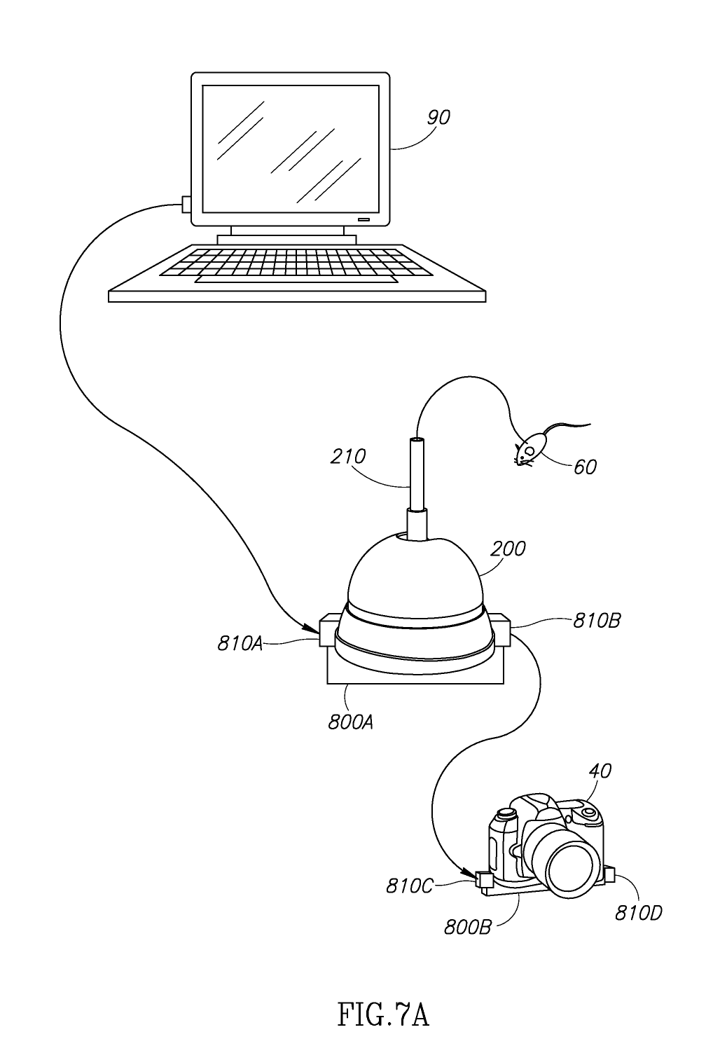

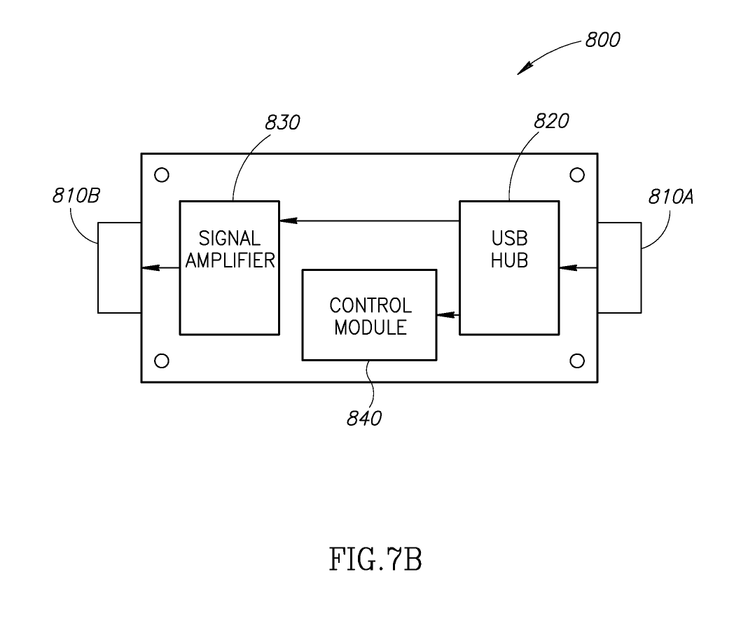

In an alternative embodiment to the present invention, base 200 may also comprise a USB repeater 800 and two USB connectors 810A and 810B as is illustrated in FIG. 7A to which reference is now made. It will be appreciated that, since there are two connectors 810 on base 200 and since base 200 may support either camera 40 or accessory 60, accessories 60 and cameras 40 may be connected to each other in series with USB cables. As is illustrated in FIG. 7A, repeater 800A (connected to base 200 and accessory 60) may provide power to repeater 800B (connected to camera 40) via USB connector 810C, allowing for camera 40 to be positioned further from computer 90 than a regular USB cable or Bluetooth connection may typically allow. It will be appreciated that repeater 800B may be connected to a further repeater via connection 810D etc. It will be further appreciated that this power boost between bases 800A and 800A may also ensure faster video streaming and less delay.

Reference is now made to FIG. 7B which illustrates the elements of repeater 800. Repeater 800 may comprise a USB hub 820, a signal amplifier 830 and a control module 840. Control module 840 may control the pertinent device attached to repeater 800, either camera 40 or base 200 together with accessory 60. The incoming signal via connector 810A may enter USB hub 820 which may enable the signal to pass instructions to control module 840. USB hub 820 may also send a signal to signal amplifier 830. Signal amplifier 830 may then amplify the signal to be sent to the next repeater 800 via connector 810B ensuring strength of signal over distance.

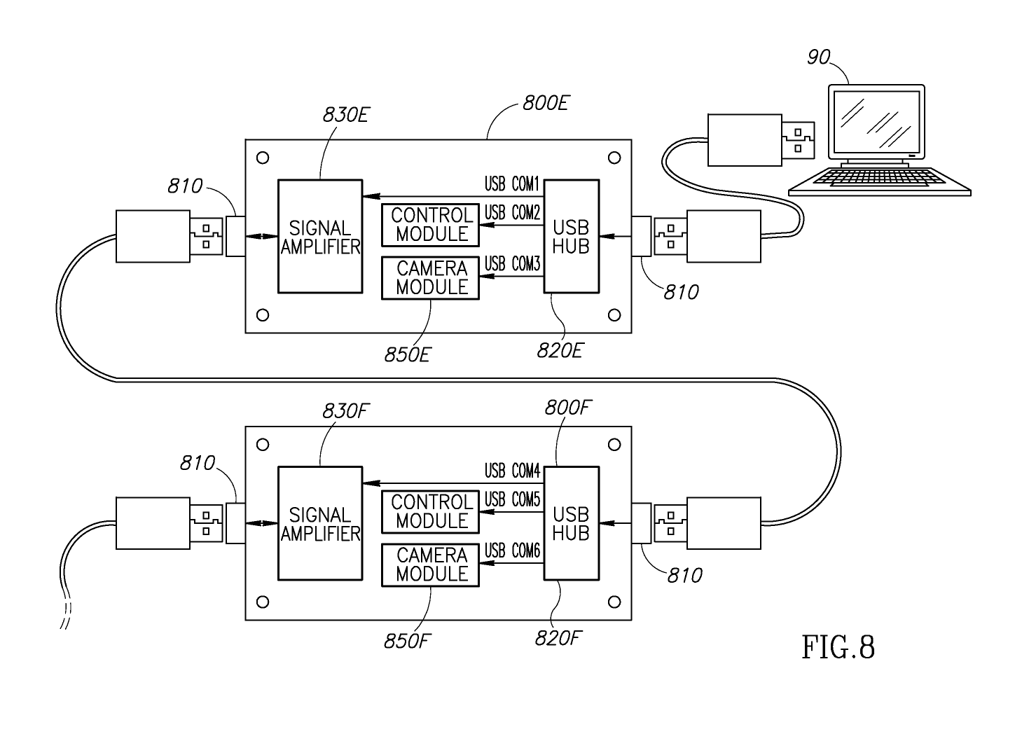

In an alternative embodiment to the present invention, several cameras 40 attached to repeaters 800 (such as 800E and 800F as illustrated) may be connected in such a manner to provide a series of remotely controlled security cameras, as illustrated in FIG. 8 to which reference is now made, overcoming the need for multiple cables and allowing for remote viewing via the IP addresses of the cameras. As is illustrated, repeater 800E may power camera module 850A and may also provide a strong enough signal to repeater 800F to power camera module 850B etc.

Cats do not remain stationary for long periods of time and it is not guaranteed that cat 10 will be in line of sight when owner 20 wants to view and interact with it. In an alternative embodiment, owner 20 may wish to determine if cat 10 is situated in the area of accessory 60 or was recently there. One option may be to use camera 40, if it is remotely controllable, to pan the area using non line of sight controller 50 to see if cat 10 is present. Another option is to track cat 10 as he moves, typically with a motion tracker, such as BitmapData API in Flash 8, commercially available from Adobe Systems Inc. of the United States. Thusly, owner 20 may know if the cat was recently present within range of camera 40 and therefore was within the area of accessory 60.

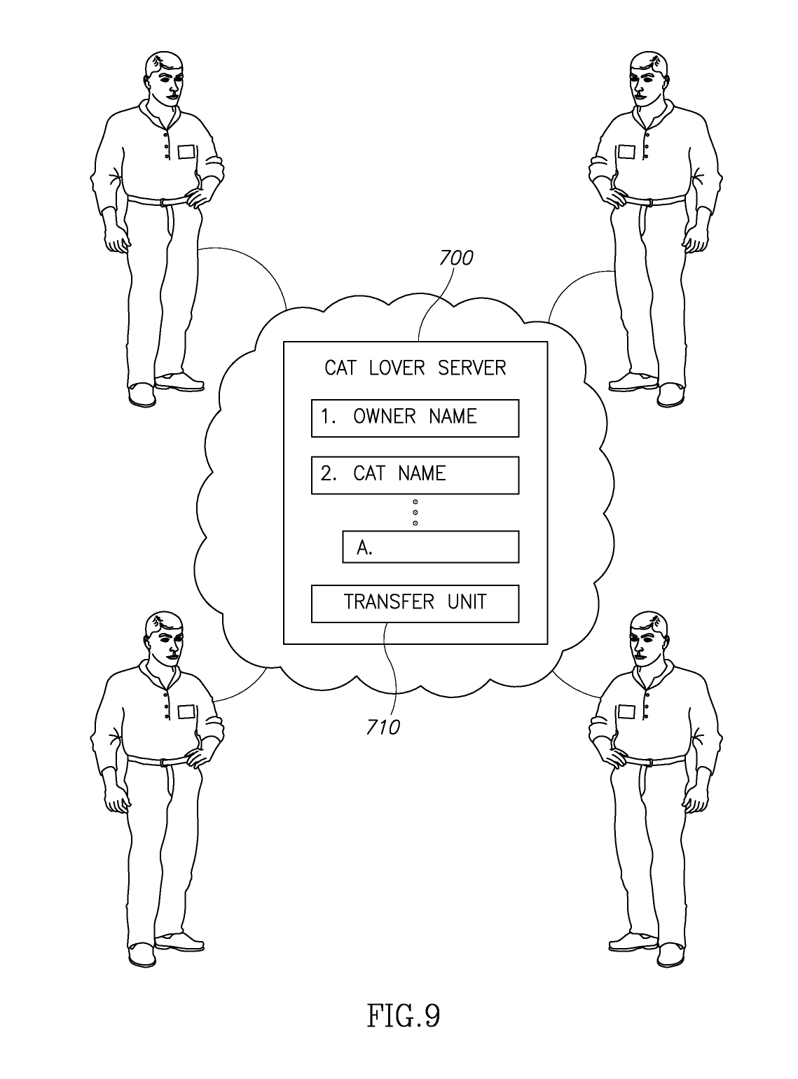

In a further alternative embodiment of the present invention, owner 20 may be part of a cyber-community of cat lovers which may allow its members to share cat owner tips and home cat videos and may also allow its members to share information regarding animal game 70 to allow other cat lovers to interact with their own cats. Reference is now made to FIG. 9 which illustrates a cat lover server 700 implementable as a standalone network or as part of a social network such as Facebook. Cat lover server 700 may store pertinent information about its members such as owner name, cat name and cat type as well as animal game sharing information. It will be appreciated that members may interact with the cat lover server 700 via their home computer 90 or via their remote communication device 80 accordingly via the available communication network.

Server 700 may comprise a transfer unit 710 which may enable a cat owner to temporarily transfer control of the remote interaction with his/her cat to another member of the community for a pre-determined length of time. To do this, server 700 may provide the IP address of the home computer 90 of the owner to the communication device 80 of the other member.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for remote interaction with a household pet implementable on a computing device, the system comprising:
a remote sight display displaying a video feed received via a communication network from a stationary live video camera viewing a location housing said household pet and at least one remotely controllable accessory; and
a non-line of sight remote controller to receive commands from a user viewing said remote sight display to control, via said communication network, the movement of said at least one remotely controllable accessory with which said pet interacts in response to said movement.

2. The system according to claim 1 and wherein said non-line of sight controller comprises a modem to send said commands to a home module.

3. The system according to claim 2 and wherein said home module is installable on a personal computer or mobile communication device.

4. The system according to claim 2 and wherein said home module comprises a coordinator to receive said commands and to instruct said at least one remotely controllable accessory to move accordingly.

5. The system according to claim 2 and wherein said home module comprises a video communication module to receive said video feed from said camera and to send said video feed to said remote sight display.

6. The system according to claim 1 and wherein said device is at least one of a mobile communication device and a personal computer.

7. The system according to claim 1 and wherein said live video camera is at least one of a webcam, an IP camera, a USB camera and a Bluetooth camera.

8. The system according to claim 1 and wherein said communication network is at least one of a cellular communication network and the internet.

9. The system according to claim 1 and wherein said accessory is said live video camera.

10. The system according to claim 1 and wherein said accessory comprises a multi-purpose base attachable to a piece of furniture.

11. The system according to claim 10 and wherein said accessory comprises a pet friendly toy attached to said base via a rotatable rod.

12. The system according to claim 1 and wherein said accessory is a dry food dispenser

13. The system according to claim 1 and wherein said accessory is a wet food dispenser.

14. The system according to claim 1 and wherein said accessory is a water dispenser.

15. The system according to claim 6 and wherein said base comprises a USB repeater and at least two USB connectors.

16. A method for remote interaction with a household pet implementable on a computing device comprising;
displaying the state of at least one remotely controllable accessory via a communication network; and
controlling movement of said at least one controllable accessory according to an interaction of said pet with said accessory.

17. The method according to claim 16 and wherein said controlling comprises sending commands to a home module via a modem.

18. The method according to claim 17 and wherein said home module is installable on a personal computer or mobile communication device.

19. The method according to claim 17 and wherein said home module comprises a coordinator to receive said commands and to instruct said at least one remotely controllable accessory to move accordingly.

20. The method according to claim 17 and wherein said home module comprises a video communication module to receive a video feed from a camera and to send said video feed to a remote sight display.

21. The method according to claim 20 and wherein said camera is at least one of a webcam, an IP camera, a USB camera and a Bluetooth camera.

22. The method according to claim 16 and wherein said communication network is at least one of a cellular communication network and the internet.

23. The method according to claim 16 and wherein said accessory is said live video camera.

24. The method according to claim 16 and wherein said accessory comprises a multi-purpose base attachable to a piece of furniture.

25. The method according to claim 24 and wherein said accessory comprises a pet friendly toy attached to said base via a rotatable rod.

26. The method according to claim 16 and wherein said accessory is a dry food dispenser

27. The method according to claim 16 and wherein said accessory is a wet food dispenser.

28. The method according to claim 16 and wherein said accessory is a water dispenser.

29. The method according to claim 24 and wherein said base comprises a USB repeater and at least two USB connectors.
